(19) United States
(12) Patent Application Publication
(10) Pub. No.: US 2012/0235487 A1
(43) Pub. Date: Sep. 20, 2012

(54) Grid backfeed prevention system

(76) Inventor: Drew Bowen, Watkinsville, GA (US)

(21) Appl. No.: 13/374,394

(22) Filed: Dec. 27, 2011

Related U.S. Application Data
(60) Provisional application No. 61/460,160, filed on Dec. 27, 2010.

(51) Int. Cl. H02J 9/00

(52) U.S. Cl. 307/64

(57) ABSTRACT

The invention provides a system and method for controlling power draw from an auxiliary power system to prevent deleterious backfeed to an external power grid. In an illustrative embodiment power levels from a photovoltaic auxiliary array are read by current transformers, which trigger a programmable logic unit to toggle a switch open or closed at threshold levels of difference between the grid's current and the photovoltaic current.

### APPLICATION PRIORITY

This application claims priority from a provisional U.S. patent application having the same title and filed by the same inventor on Dec. 27, 2011, Ser. No. 61/460,160.

### FIELD OF THE INVENTION

The invention pertains to a system and method for preventing backfeed to power grids from auxiliary power generating systems.

### BACKGROUND OF THE INVENTION

In recent decades both public and private institutions have placed ever-growing emphasis on improving the sustainability of power resources. “Green” technologies that have been embraced by this trend include (among others) photovoltaics, windmills, and geothermal energy capture. However the adoption of such technologies to reduce reliance on the traditional power grid is hampered by engineering issues that are largely unnoticed by the general public.

A particularly important issue arises because current photovoltaic facilities for most buildings cannot generate enough energy to supply the entire power need. Consequently solar electricians must harmonize photo-powered circuit specifications with those of the conventional power grid for switching between them, which is most feasible when some leakage of power from the photovoltaic circuit to the community grid is tolerable. Many consumers are aware that producers of auxiliary power in many locales sell surplus electricity and transmit it to the power grid. It is less well known that many large metropolitan areas have ungrounded or under-grounded power networks that must be exposed to virtually no electrical backfeed from the supplemental power source. Consequently such locales tend to have no solar facilities, or have only very large and expensive systems. Indeed at a recent premier conference on solar photovoltaics (PV AMERICA, Jun. 8-10, 2009, Philadelphia), industry representatives lamented the lack of solutions and equipment for preventing photovoltaic backfeed to the power grid. Indeed, the present inventor witnessed the cancellation of a 100 kW installation project because no solution was known for this problem.

Thus there is an ongoing need for improved circuits to backfeed into power grids from auxiliary power sources.

### BRIEF DESCRIPTION OF THE INVENTION

The invention provides a switching system that meters grid access as a function of power characteristics in an auxiliary power circuit.

### BRIEF DESCRIPTION OF THE DRAWINGS

FIG. 1 is an illustrative caricature exemplifying a switching circuit according to the invention.

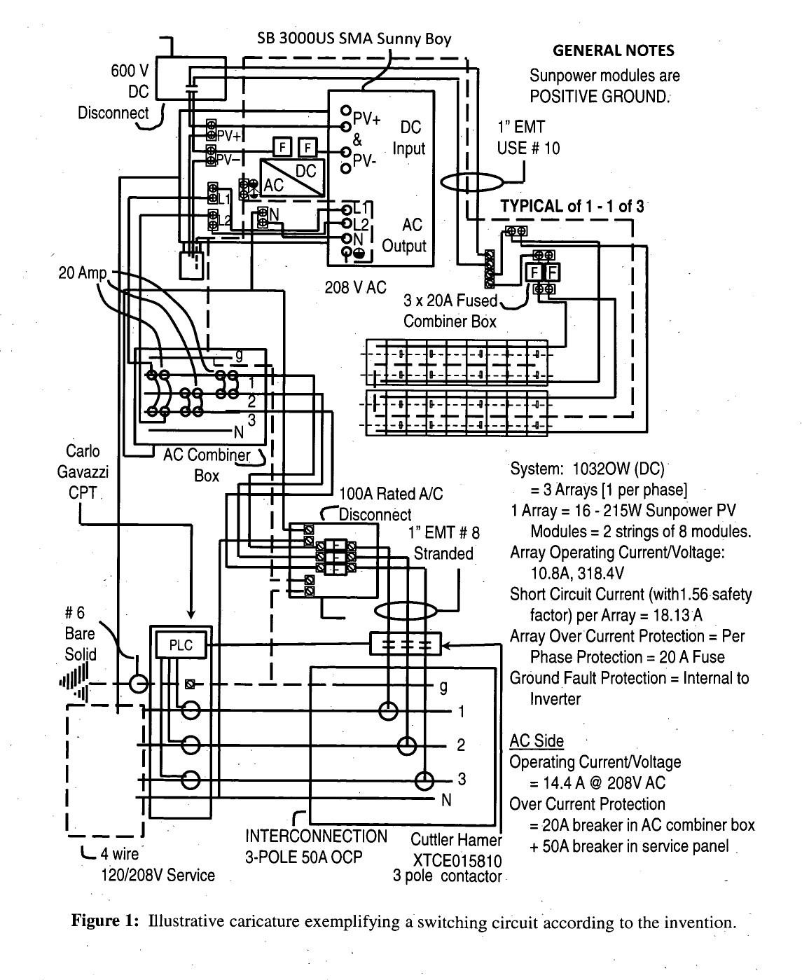

FIG. 2 is an illustrative caricature exemplifying a panel-side view of solar arrays suitable for the invention.

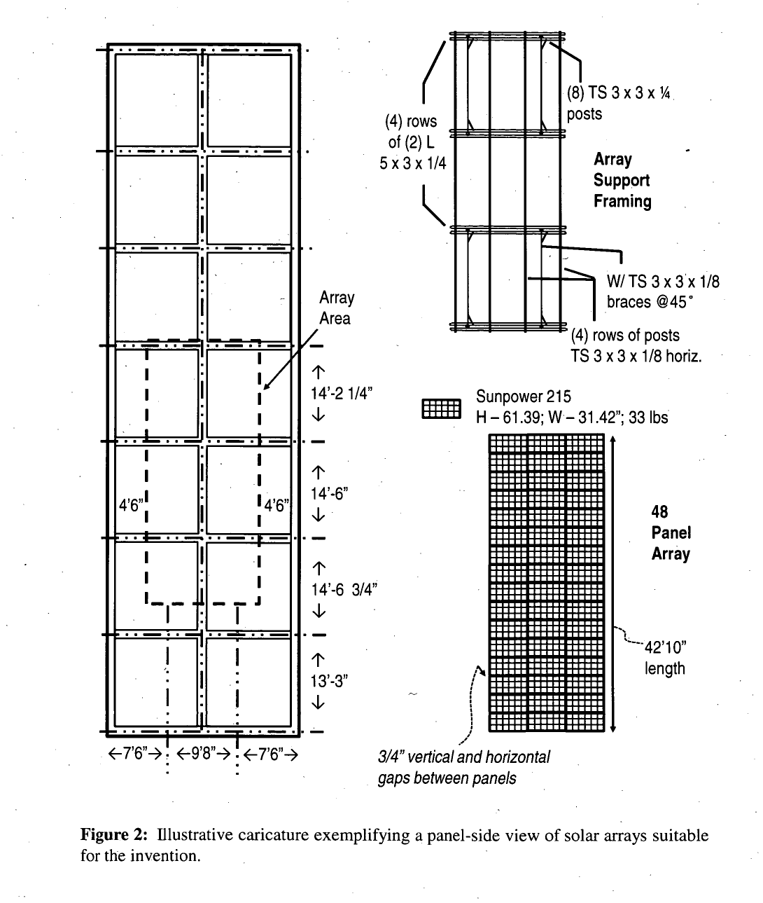

FIG. 3 is an illustrative caricature exemplifying a transverse view of solar arrays suitable for the invention.

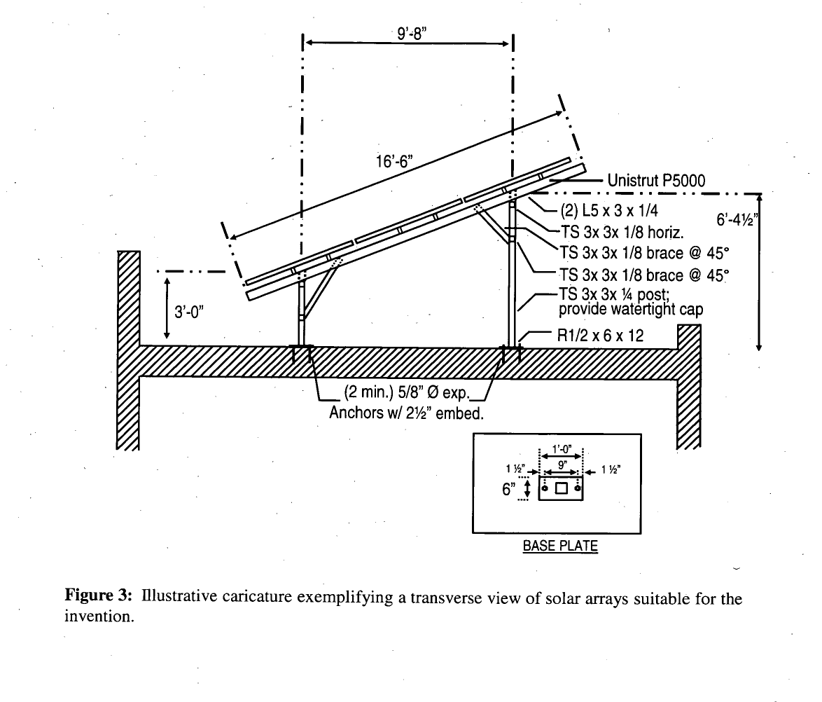

FIG. 4 is an illustrative caricature exemplifying an end-wise view of solar arrays suitable for the invention.

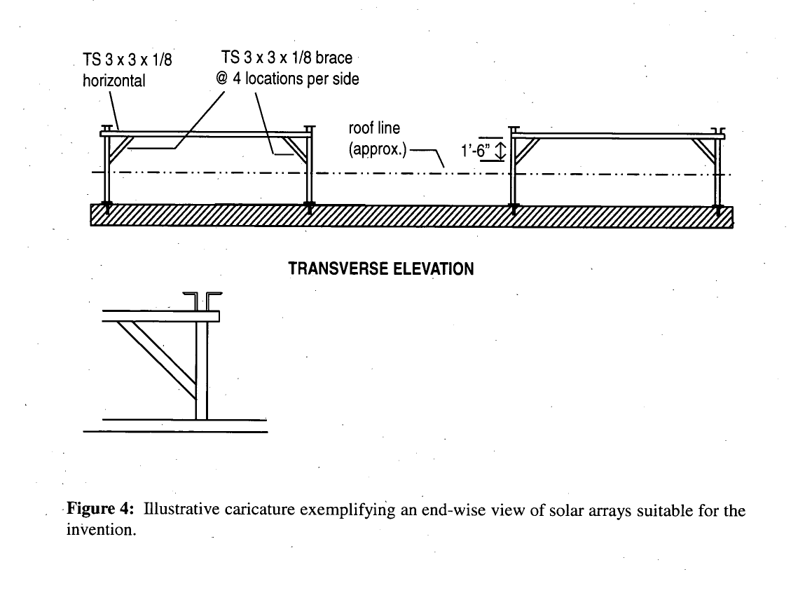

### DETAILED DESCRIPTION OF THE INVENTION

The invention provides a switching system that meters grid access as a function of power characteristics in an auxiliary power circuit.

The following abbreviations are used in this description and or the drawings.
CT—current transformer
CPT—compact power transducer
EMT—metallic tubular raceway used for carrying wires.
OCP—overcurrent protection
PLC—programmable logic controllers
PLU—programmable logic unit
PV—photovoltaic
SMA—(subminiature A) coaxial cables and connectors

In an illustrative embodiment a system according to the invention has CTs that read the power levels coming in from the PV array. When they reach desired levels for permitting current wires from the power grid, the CTs trigger a PLU to flip a switch. Typical threshold levels from power companies in the Georgia area are at about 2 A or 2% of current capacity, but the invention is not so limited and could be for instance 5 A or another current threshold. In any case, when the PV power output falls to the predetermined low threshold, the circuit opens a contactor through which an inverter is running, i.e., the PV array circuit is off. The contactor is closed again when the difference between the grid and PV circuit reaches a predetermined high threshold. In illustrative embodiments the high threshold is a difference of 30 A or 40 A. Amperage is a convenient metric because voltage and wattage are harder to measure, but the invention is not so limited.

In one illustrative embodiment a building has a rooftop PV array with 30 A capacity. During hours of regular use the building's typical power draw is 60 A.

When buildings are in their times of lowest use, alternating current needs to be shut off. Using a breaker, an inverter in circuits according to the invention receives no AC power when the contacts are open.

I claim:

1) A system for preventing electrical backfeed in a power consuming facility comprising:
a) one or more transmission lines from an auxiliary power source in a power consuming facility, wherein each transmission line is in electrical communication with a power-reading current transformer (PRCT);
b) one or more transmission lines from an external power grid in the power consuming facility;
c) a programmable logic unit (PLU) that is in electrical communication with one or more PRCTs from the auxiliary power transmission line(s), wherein the PLU recognizes power levels by means of current from the PRCT(s) and has a predetermined lower threshold and upper threshold for current;
d) a contactor in electrical communication with the PLU, wherein under the control of the PLU the contactor isolates the auxiliary power source in an open circuit condition at the lower threshold for current and connects the auxiliary power source in a closed circuit condition at the upper threshold for current, such that the auxiliary power source and power grid may be online simultaneously in the same power consuming facility without deleterious levels of electrical backfeed to the power grid from the auxiliary power source.

2) A method for preventing electrical backfeed in a power consuming facility comprising:
a) monitoring power output from one or more transmission lines from an auxiliary power source in a power consuming facility, by means of a power-reading current transformer (PRCT) in electrical communication with one or more of the auxiliary power-reading transmission lines;
b) assessing harmonization suitability of the auxiliary power output by means of a programmable logic unit (PLU) that is in electrical communication with one or more PRCTs from the auxiliary power transmission line(s), wherein the PLU recognizes power levels by means of current from the PRCT(s) and has a predetermined lower threshold and upper threshold for current;
c) activating a contactor in electrical communication with and under the control of the PLU, wherein the contactor isolates the auxiliary power source in an open circuit condition at the PLU's lower threshold for its current, and connects the auxiliary power source in a closed circuit condition at the PLU's upper threshold for its current, such that the auxiliary power source and an external power grid may be online simultaneously in the same power consuming facility without deleterious levels of electrical backfeed to the power grid from the auxiliary power source.
